(19) United States
(12) Patent Application Publication
(10) Pub. No.: US 2016/0233820 A1
(43) Pub. Date: Aug. 11, 2016

(54) END HOLDER AND FASTENING SYSTEM FOR MOUNTING SOLAR MODULES

(71) Applicant: Mounting Systems GmbH, Rangsdorf (DE)

(72) Inventor: Mark Redel, Blankenfelde-Mahlow (DE)

(21) Appl. No.: 14/950,816

(22) Filed: Nov. 24, 2015

(30) Foreign Application Priority Data
Nov. 26, 2014 (DE) 202014009489.6

(51) Int. Cl. H02S 20/23; F24J 2/52

(52) U.S. Cl. CPC H02S 20/23; F24J 2/5258; F16B 5/121

(57) ABSTRACT

A height-adjustable end holder for fastening solar modules of different heights on a profile rail, has an accommodating-bracket element, formed from a first and a second accommodating limb, wherein a mount for a solar module is formed on the first accommodating limb, having a fastening element for fastening on a profile rail, and having an adjustment element, which fastens the accommodating-bracket element in a height-adjustable manner on the fastening element so that in a mounted state it can subject the solar module to a contact pressure via the mounting. The second accommodating limb, on its side directed towards the first accommodating limb, has a first sawtooth profile, and the fastening element, on its side directed towards the second accommodating limb, has a second sawtooth profile, such that in the mounted state movement is blocked, and in a non-mounted state movement in the height direction is possible.

### CROSS REFERENCE TO RELATED APPLICATION

This application claims priority under 35 USC §119 to German Patent Application No. 20 2014 009 489.6 filed on Nov. 26, 2014, which application is hereby incorporated by reference in its entirety.

### TECHNICAL FIELD

The invention relates to an end holder and to a fastening system for mounting solar modules.

### BACKGROUND OF THE INVENTION

Solar modules, for example photovoltaic modules for generating electrical energy or collector modules for heating heat transfer media, are mounted, usually on roofs or in open land, on profile rails which are arranged parallel to one another. There is a wide range of solar modules available, differing in terms of dimensions and possible arrangements. Different types of solar modules have different module heights. This relates, in particular, to framed solar modules. Mounting systems for solar modules should therefore be capable of being used in as variable a manner as possible and should allow quick and straightforward mounting operations.

DE 20 2013 005 668 discloses a height-adjustable end holder which can be adjusted, with the aid of a height-adjustment element, such that it can be used for modules of different heights. The height adjustment which is necessary for this purpose takes place in a stepwise manner.

A first aspect of the present invention relates to a height-adjustable end holder for fastening solar modules of different heights on a profile rail,
having an accommodating-bracket element, which is formed from a first and a second accommodating limb, wherein a mount for a solar module is formed on the first accommodating limb,
having a fastening element for fastening on a profile rail, and
having an adjustment element, which fastens the accommodating-bracket element in a height-adjustable manner on the fastening element and is designed so that in a mounted state, with the mounting being at an adjustable distance from the profile rail, it can subject the solar module that is to be mounted to a contact pressure via the mounting,
wherein the second accommodating limb, on its side directed towards the first accommodating limb, has a first sawtooth profile,
the fastening element, on its side directed towards the second accommodating limb, has a second sawtooth profile, and
wherein the first sawtooth profile and the second sawtooth profile are designed such that in the mounted state, under the contact pressure of the adjustment element, movement of the accommodating-bracket element relative to the fastening element in a height direction, which is perpendicular to a longitudinal direction of the profile rail, is blocked, and in a non-mounted state movement of the accommodating-bracket element relative to the fastening element in the height direction is possible.

The end holder according to the invention is intended for retaining precisely one solar module, for example at the end of a row of solar modules. In contrast to a module holder, which is arranged between two modules and in the case of which the modules themselves each form the stop, it is necessary for the end holder, since it is used to fasten just one module, itself to provide the stop.

The invention makes it possible to adjust different height settings of the mount of the end holder via two sawtooth profiles which are directed towards one another on an accommodating-bracket element and a fastening element. This solution has the advantage that it allows particularly easily manageable, more or less stepless, and thus particularly precise, height adjustment. At the same time, the sawtooth profiles provide for particularly reliable adjustment of the desired height in the mounted state. The present invention thus achieves the advantage of providing an improved mounting system and a simplified end holder which can be used in a variable manner for different module heights. In the case of the end holder according to the present invention, it is possible for the height to be adjusted on a preliminary basis in the non-mounted state via the displacement of the fastening element and of the accommodating-bracket element in relation to one another and to be adjusted precisely in the mounted state with the aid of the adjustment element. This allows different modules to be mounted in a straightforward manner.

The distance between the mount of the end holder and a profile rail, on which the end holder is mounted, that is to say the height adjustment, is formed, in the case of the end holder according to the invention, from displacement of the fastening-bracket element relative to the accommodating-bracket element. Displacement of the sawtooth profiles in relation to one another thus allows straightforward adjustment. The height adjustment is possible more or less in a stepless manner, since the distance between adjacent height-adjustment settings is dependent only on the width of an individual sawtooth of the sawtooth profile.

Embodiments and preferred applications of the height-adjustable end holder will be described hereinbelow.

In a preferred embodiment, the fastening element is a clip holder, having a head plate with a threaded bore and two clip-holder limbs, which are arranged laterally, opposite one another, on the head plate and of which the ends directed away from the head plate have hooks, which are designed to engage behind curved or bent formations, wherein the second sawtooth profile extends on narrow sides of the clip-holder limbs and on a narrow side of the head plate, the latter narrow side being located between the clip-holder limbs.

In an alternative embodiment, the fastening element has a clip holder having a head plate with a threaded bore and two clip-holder limbs, which are arranged laterally, opposite one another, on the head plate and of which the ends directed away from the head plate have hooks, which are designed to engage behind curved or bent formations, and a fastening-bracket element, which is formed by a first and a second fastening limb, wherein the second sawtooth profile is formed on the second fastening limb. It is preferred, in a further embodiment, for the fastening-bracket element to be fastened on the clip holder via the adjustment element.

The use of fastening elements which comprise a clip holder is advantageous since clip holders can be fastened quickly and straightforwardly on profile rails and thus contribute towards easily manageable mounting.

In a preferred embodiment, the adjustment element is a screw.

According to a second aspect, the invention relates to a fastening system which comprises at least one end holder according to the invention and at least one profile rail, on which the end holder is fastened.

In one embodiment, the end holder is designed to retain module or frame heights ranging from 30 to 50 mm. It is likewise possible to realize other module or frame heights, and these can be made possible by adapting the length of the accommodating-bracket element and of the fastening element.

According to a preferred application of the end holder, this forming a second aspect of the invention, the fastening system comprises at least one end holder according to the first aspect of the invention, or one of the embodiments thereof, and at least one profile rail, on which the end holder is fastened.

In one embodiment of the fastening system, the end holder is mounted transversely to the profile rail. This means that the second accommodating limb, in the mounted state, is arranged transversely to the profile rail. In a further embodiment of the fastening system, the end holder is mounted parallel to the profile rail.

### BRIEF DESCRIPTION OF THE DRAWINGS

Further features and advantages will become apparent from looking at the exemplary embodiments which are described hereinbelow with reference to the figures, in which:

FIG. 1 shows a perspective illustration of an embodiment of a height-adjustable end holder,

FIG. 2 shows a perspective illustration of an embodiment of a fastening system, seen in part, and

FIG. 3 shows schematically different height-adjustment settings of an embodiment of the height-adjustable end holder in a fastening system.

### DETAILED DESCRIPTION

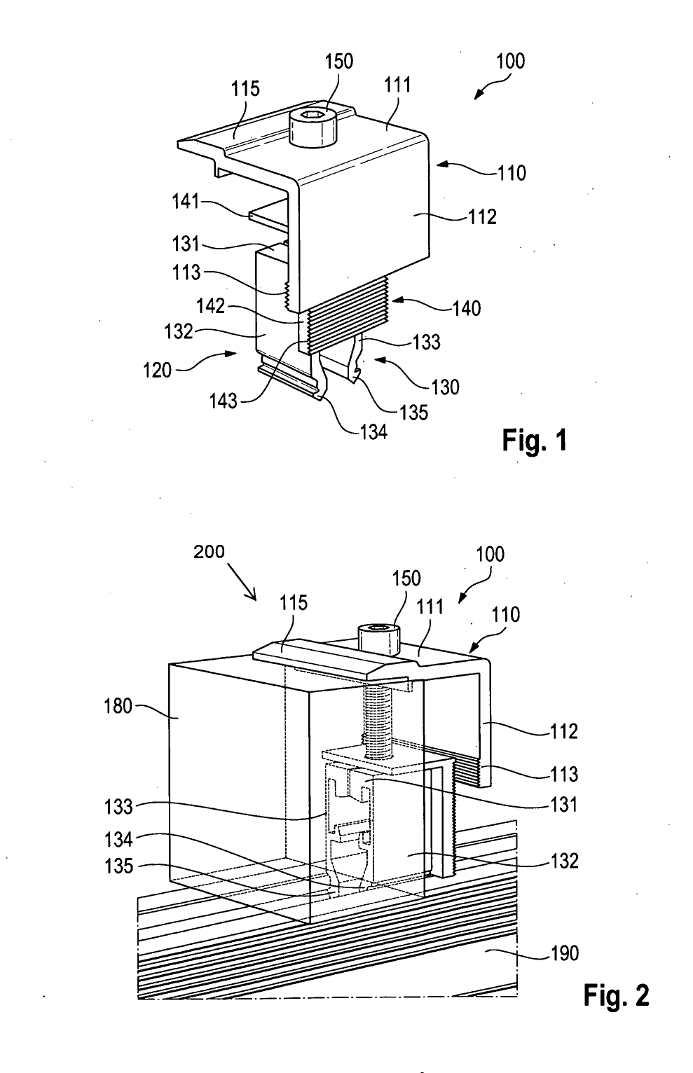

FIG. 1 shows an embodiment of a height-adjustable end holder 100 according to the first aspect of the invention.

The end holder 100 has an accommodating-bracket element 110 and a fastening element 120 and an adjustment element 150. In the present embodiment, the adjustment element 150 is designed in the form of a screw. The adjustment element is designed here so that in a mounted state (not illustrated here), with the mount 115 at an adjustable distance from the profile rail, it can subject the solar module which is to be mounted to a contact pressure via the mount 115. The accommodating-bracket element 110 is formed by a first accommodating limb 111 and a second accommodating limb 112. A mount 115 for a solar module is formed on the first accommodating limb 111. Furthermore, the first accommodating limb 111 has a bore for accommodating the adjustment element 150. A first sawtooth profile 113 is arranged on the second accommodating limb 112, on that side of the latter which is directed towards the first accommodating limb 111. In the embodiment shown, the fastening element 120 has a clip holder 130 and a fastening-bracket element 140. The fastening-bracket element 140 is formed by a first fastening limb 141 and a second fastening limb 142. The first fastening limb 141, like the first accommodating limb 111, has a bore (not visible here) for accommodating the adjustment element. A second sawtooth profile 143 is arranged on the second fastening limb 142, on that side of the latter which is directed towards the second accommodating limb 112. The clip holder 130 has a head plate 131 with a threaded bore, for accommodating the adjustment element 150, and two clip-holder limbs 132, 133, which are arranged laterally, opposite one another, on the head plate 131 and of which the ends directed away from the head plate have hooks 134, 135, which are designed to engage behind curved or bent formations. The accommodating-bracket element 110 is fastened in a height-adjustable manner on the fastening element 120 by the adjustment element 150. The first sawtooth profile 113 and the second sawtooth profile 143 are designed such that in a mounted state (not illustrated here), under the contact pressure of the adjustment element 150, movement of the accommodating-bracket element 110 relative to the fastening element 120 in a height direction, which is perpendicular to the longitudinal direction of the profile rail, is blocked, and in the non-mounted state (shown here) movement of the accommodating-bracket element 110 relative to the fastening element 120 in the height direction is possible.

FIG. 2 shows a perspective view of an embodiment of a fastening system 200, according to the second aspect of the invention, having an end holder 100 embodied as illustrated in FIG. 1. The fastening system 200 comprises an end holder 100, and the latter is fastened on a profile rail 190. The solar module 180 which is to be mounted is symbolized here by a transparent cuboid. It can be seen in this perspective view that the mount 115 of the end holder, said mount being fitted on the first accommodating limb 111, accommodates the solar module 180 and the profile rail is subjected to contact pressure via the adjustment element 150, designed in the form of a screw, being tightened. In the mounted state here, the clip holder 130 engages in the profile rail 190 by way of the hooks 134, 135, which are formed on the clip-holder limbs 132, 133, and thus ensures easily manageable fastening on the profile rail 190. The head plate 131 of the clip holder 130 has a threaded bore, in which the adjustment element 150 is accommodated. As can be seen in this view, the first sawtooth profile 113, in the embodiment shown here, is formed only over part of the length of the second accommodating limb 112. As an alternative, in an embodiment which is not shown here, it is also possible for the sawtooth profile 113 to be formed over the entire length of the second accommodating limb 112.

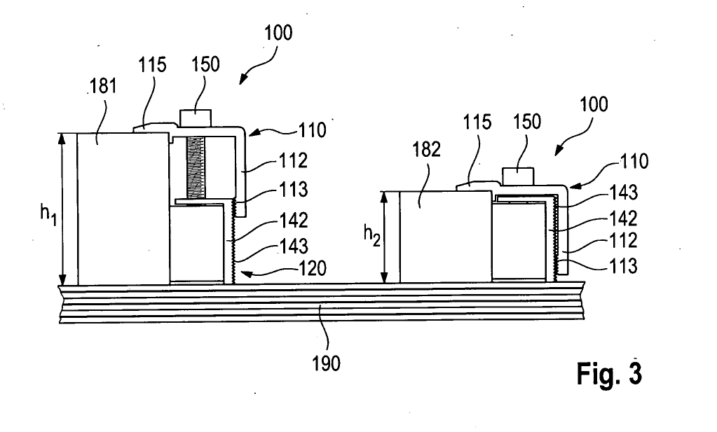

FIG. 3 shows schematically how it is possible to realize different module heights using a height-adjustable end holder 100, according to the first aspect of the invention, in a fastening system. In the embodiment shown, the module 181 has a module height of approximately 50 mm and the module 182 has a module height of approximately 30 mm. The different heights h1 and h2 by which the mount 150 is positioned above the profile rail 190 are realized by a movement of the accommodating-bracket element 110 relative to the fastening element 120. The adjustment element 150 ensures that contact pressure prevails in the mounted state, and it is therefore no longer possible for the sawtooth profiles 143 and 113 to be displaced in relation to one another. The second accommodating limb 112 of the accommodating-bracket element 110 and the second fastening limb 142 together provide the stop heights h1 and h2 by virtue of the overlapping of the accommodating limb 112 and of the fastening limb 142, said overlapping being set in each case via the adjustment element 150.

What is claimed is:

1. A height-adjustable end holder for fastening solar modules of different heights on a profile rail, comprising:
an accommodating-bracket element, which is formed from a first and a second accommodating limb, wherein a mount for a solar module is formed on the first accommodating limb,
having a fastening element for fastening on a profile rail, and
having an adjustment element, which fastens the accommodating-bracket element in a height-adjustable manner on the fastening element and is designed so that in a mounted state, with the mounting being at an adjustable distance from the profile rail, it can subject the solar module that is to be mounted to a contact pressure via the mounting,
wherein the second accommodating limb, on its side directed towards the first accommodating limb, has a first sawtooth profile,
the fastening element, on its side directed towards the second accommodating limb, has a second sawtooth profile, and
wherein the first sawtooth profile and the second sawtooth profile are designed such that in the mounted state, under the contact pressure of the adjustment element, movement of the accommodating-bracket element relative to the fastening element in a height direction, which is perpendicular to a longitudinal direction of the profile rail, is blocked, and in a non-mounted state movement of the accommodating-bracket element relative to the fastening element in the height direction is possible.

2. The end holder according to claim 1, wherein the fastening element is a clip holder,
having a head plate with a threaded bore and two clip-holder limbs, which are arranged laterally, opposite one another, on the head plate and of which the ends directed away from the head plate have hooks, which are designed to engage behind curved or bent formations,
wherein the second sawtooth profile extends on narrow sides of the clip-holder limbs and on a narrow side of the head plate, the latter narrow side being located between the clip-holder limbs.

3. The end holder according to claim 1, wherein the fastening element has:
a clip holder having a head plate with a threaded bore and two clip-holder limbs, which are arranged laterally, opposite one another, on the head plate and of which the ends directed away from the head plate have hooks, which are designed to engage behind curved or bent formations, and
a fastening-bracket element, which is formed by a first and a second fastening limb, wherein the second sawtooth profile is formed on the second fastening limb.

4. The end holder according to claim 3, wherein the adjustment element fastens the fastening-bracket element on the clip holder.

5. The end holder according to claim 4, in the case of which the adjustment element is a screw.

6. A fastening system comprising at least one end holder according to claim 1 and at least one profile rail, on which the end holder is fastened.

7. The end holder according to claim 1, in the case of which the adjustment element is a screw.
